(19) United States
(12) Patent Application Publication
(10) Pub. No.: US 2018/0181110 A1
(43) Pub. Date: Jun. 28, 2018

(54) SYSTEM AND METHOD OF GENERATING A CUSTOM EYEBROW STENCIL

(71) Applicant: Dawn Camarda, Alpharetta, GA (US)

(72) Inventor: Dawn Camarda, Alpharetta, GA (US)

(21) Appl. No.: 15/390,635

(22) Filed: Dec. 26, 2016

(51) Int. Cl. G05B 19/4097; A45D 40/30; A45D 44/00; B29C 67/00; B33Y 10/00; B33Y 50/02; B33Y 80/00

(52) U.S. Cl. CPC G05B 19/4097; A45D 40/30; A45D 44/005; B29C 67/0088; B29L 2031/718; B33Y 50/02; B33Y 80/00; G05B 2219/49023; B33Y 10/00

(57) ABSTRACT

A system and method for generating an eyebrow stencil comprises a user device. The user device comprises a camera, and a memory unit. The make-up artist module is configured to process the image to determine a plurality of eyebrow metrics, compare the plurality of eyebrow metrics with the plurality of eyebrow stencil metrics associated with each of the plurality of eyebrow stencil templates, and select at least one eyebrow stencil template from the plurality of eyebrow stencil templates based on the plurality of eyebrow metrics being identical to the plurality of eyebrow stencil metrics associated with the at least one eyebrow stencil template. The system further comprises a make-up artist device configured to receive information regarding the at least one eyebrow stencil template from the user device, and generate an eyebrow stencil based on the at least one eyebrow stencil template.

### BACKGROUND OF THE INVENTION

### A. Technical Field

The present invention generally relates to the technical field of eyebrow stencils and more specifically relates to a system and method of a generating a custom eyebrow stencil for a user. The present invention further relates to combining a cosmetic product and a mobile application wherein the mobile application obtains facial measurements and generates stencils to enable users to apply the cosmetic product.

### B. Description of Related Art

Studies have shown that beauty, as perceived by others, is predominantly determined by symmetry present in a facial structure of a person. Appearance of the facial structure is largely dependent on shape of eyebrows. Hence, in order to bolster physical appearance, women often tend to modify shape of eyebrows. Women employ a plurality of means to modify the shape of the eyebrows. For example, women use tattooing, coloring, piercing, makeup, and shaping in order to modify the eyebrows. Even though in most cases, women employ shaping to modify the eyebrows, several women employ eyebrow stencils to apply a pigment on the eyebrow and thereby modify appearance of the eyebrow.

Recent decades have witnessed emergence of a wide gamut of types of eyebrow stencils in the market. However, the eyebrow stencils currently available in the market have several drawbacks. For example, the eyebrow stencils have a generic design. Designers of the eyebrow stencils fail to take into account of the user's facial structure and bone structure while designing the eyebrow stencils. As a result, quite often, use of the eyebrow stencils result in modification of the eyebrows in a manner that is incompatible with the facial structure of an individual. Further, generic eyebrow stencils tend to be uncomfortable to wear.

Therefore, there is a need in the art for a system and method of a generating a custom eyebrow stencil for a user, after taking into account of the user's facial structure.

### SUMMARY OF THE INVENTION

The present invention relates to a system and method for generating a custom eyebrow stencil for a user.

In one embodiment of the present invention, a system and computer implemented method for generating an eyebrow stencil comprises a user device and a make-up artist device. The user device comprises a camera, and a memory unit. The memory unit stores information about a plurality of eyebrow stencil templates, and a set of program modules. The information comprises a plurality of eyebrow stencil metrics associated with each of the plurality of the eyebrow stencil templates. A processor executes the set of program modules. The set of program modules comprises an input module to activate the camera and capture an image of a user's face. The make-up artist module is configured to process the image to determine a plurality of eyebrow metrics, compare the plurality of eyebrow metrics with the plurality of eyebrow stencil metrics associated with each of the plurality of eyebrow stencil templates, and select at least one eyebrow stencil template from the plurality of eyebrow stencil templates based on the plurality of eyebrow metrics being identical to the plurality of eyebrow stencil metrics associated with the at least one eyebrow stencil template. The system further comprises the make-up artist device configured to receive information regarding the at least one eyebrow stencil template from the user device, and generate an eyebrow stencil based on the at least one eyebrow stencil template.

In one embodiment of the present invention, the make-up artist device is at least one of a stereolithographic 3d printer, Digital Light Processing (DLP) based 3d printer, Fused deposition modeling (FDM) based 3d printer, Selective Laser Sintering (SLS) based 3d printer, a Selective laser melting (SLM) 3d printer, Laminated Object Manufacturing (LOM) 3d printer. In another embodiment, the user device is at least one of a laptop, a desktop computer, a mobile phone, and a personal digital assistant. In yet another embodiment, the plurality of eyebrow stencil templates comprise a wireframe 3d model, a surface 3d model, and a solid 3d model. In yet another embodiment the plurality of the eyebrow stencil metrics and the plurality of eyebrow metrics comprises at least one of a length of eyebrows on the user's face, a bone structure of the user's face, a shape of the user's face, and breadth of the eyebrows.

In one embodiment of the present invention, a method of generating an eyebrow stencil, the method comprises storing in a memory unit, information about a plurality of eyebrow stencil templates, and a set of program modules. The information comprises a plurality of eyebrow stencil metrics associated with each of the plurality of the eyebrow stencil template. Further, the method comprises activating a camera by a processor, via an input module. Further, the method comprises capturing by the processor, via the input module, an image of a user's face. Further, the method comprises processing, by the processor via a make-up artist module, the image to determine a plurality of eyebrow metrics. Further, the method comprises comparing, by the processor via the make-up artist module, the plurality of eyebrow metrics with the plurality of eyebrow stencil metrics associated with each of the plurality of eyebrow stencil templates. Further, the method comprises selecting, by the processor via the make-up artist module, at least one eyebrow stencil template from the plurality of eyebrow stencil templates based on the plurality of eyebrow metrics being identical to the plurality of eyebrow stencil metrics associated with the at least one eyebrow stencil template. Further, the method comprises receiving at a make-up artist device, information regarding the at least one eyebrow stencil template from the user device. Further, the method comprises generating at the make-up artist device, an eyebrow stencil based on the at least one eyebrow stencil template.

### BRIEF DESCRIPTION OF DRAWINGS

FIG. 1 is a block diagram of an environment implemented in accordance with various embodiments of the invention.

FIG. 2 is a block diagram of a user device in accordance with various embodiments of the invention.

FIG. 3 is flow chart of a computer-implemented method of generating a custom eyebrow stencil, according to yet another embodiment of the present invention.

FIG. 4 is an exemplary illustration of an eyebrow stencil according to yet another embodiment of the present invention.

FIG. 5 is an exemplary illustration of a screenshot of a paint by number based make-up system in accordance with one embodiment of the present invention.

FIG. 6 is an exemplary illustration of a make-up kit used for a paint by number based make-up system in accordance with one embodiment of the present invention.

FIG. 7 is an exemplary illustration of a screenshot of a paint by number based make-up system in accordance with one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

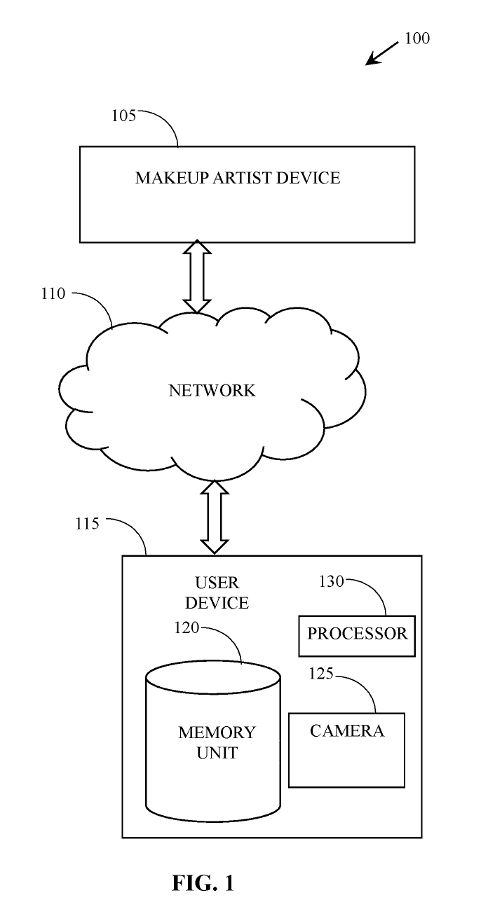

FIG. 1 is a block diagram of an environment 100 in accordance with which various embodiments of the present invention are implemented. The environment 100 comprises a make-up artist device 105, a network 110, and a user device 115. The make-up artist device 105 is at least one of a stereolithographic 3d printer, Digital Light Processing (DLP) based 3d printer, Fused deposition modeling (FDM) based 3d printer, Selective Laser Sintering (SLS) based 3d printer, a Selective laser melting (SLM) 3d printer, Laminated Object Manufacturing (LOM) 3d printer. The make-up artist device 105 is configured to receive information regarding at least one eyebrow stencil template from the user device 115, and to generate an eyebrow stencil based on the at least one eyebrow stencil template.

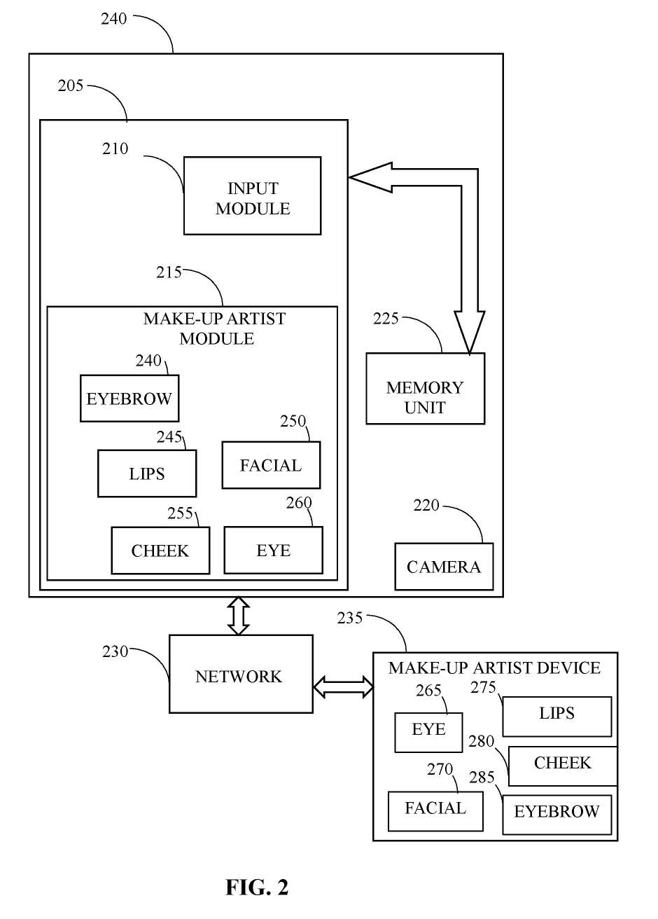

The user device 115 is at least one of a tablet computer, a personal computer, a smart phone, a smart television and a laptop. In one example, the user device 115 enables a user to communicate with the make-up artist device 105 via the network 110. The network 110 is one of a mobile network, a wide area network and a wireless radio network. The user device 115 comprises a memory unit 120, a camera 125, and a processor 130. The memory unit 120 stores information regarding a plurality of eyebrow stencil templates. The information comprises a plurality of eyebrow stencil metrics associated with each of the plurality of the eyebrow stencil templates. The plurality of eyebrow stencil templates comprise wireframe 3d models of eyebrow stencils, surface 3d models of eyebrow stencils, and solid 3d models of eyebrow stencils. The plurality of the eyebrow stencil metrics and the plurality of eyebrow metrics comprises at least one of a length of eyebrows on the user's face, a bone structure of the user's face, a shape of the user's face, and breadth of the eyebrows. The memory unit 120 further comprises a set of program modules. The set of program modules comprises an input module and a make-up artist module. The set of program modules are executable by the processor 130. The processor 130 controls the camera 125. The camera 125 is at least one of a web camera and a digital single lens refractive (DSLR) camera. A block diagram of an exemplary implementation of the user device 115 is illustrated in FIG. 2.

Referring to FIG. 2, a user device 240 is connected to a make-up artist device 235 via a network 230. The network 230 is at least one of a mobile network, a wide area network and a wireless radio network. The network 230 enables communication between the make-up artist device 235 and the user device 240. The makeup artist device 235 has an eye module 265 to generate eye contouring stencils, a facial module 270 to generate facial contouring stencils, a lip contouring module 275 to generate a lip stencil, a cheek contouring module 280 to generate a cheek/blush stencil, and an eyebrow module 285 to generate an eyebrow stencil. The user device 240 comprises a processor 205, a memory unit 225, and a camera 220. In one example, the memory unit 225 stores information regarding a plurality of eyebrow stencil templates. The information comprises a plurality of eyebrow stencil metrics associated with each of the plurality of the eyebrow stencil templates. The plurality of eyebrow stencil templates comprise wireframe 3d models of eyebrow stencils, surface 3d models of eyebrow stencils, and solid 3d models of eyebrow stencils. The plurality of the eyebrow stencil metrics comprises at least one of a length of eyebrows on a user's face, a bone structure of the user's face, a shape of the user's face, and breadth of the eyebrows. The memory unit 225 further comprises a set of program modules. The set of program modules comprises an input module 210 and a make-up artist module 215. The processor 205 executes the set of program modules. The input module 210 activates the camera 220. Further, the input module 210 captures an image of the user's face. The image is stored in the memory unit 225 as at least one of a .bmp, .jpg, and .png file. Further, the input module 210 transmits the image to the make-up artist module 215.

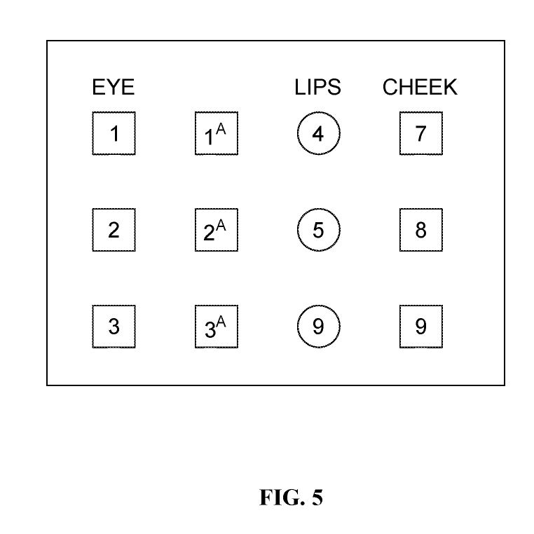

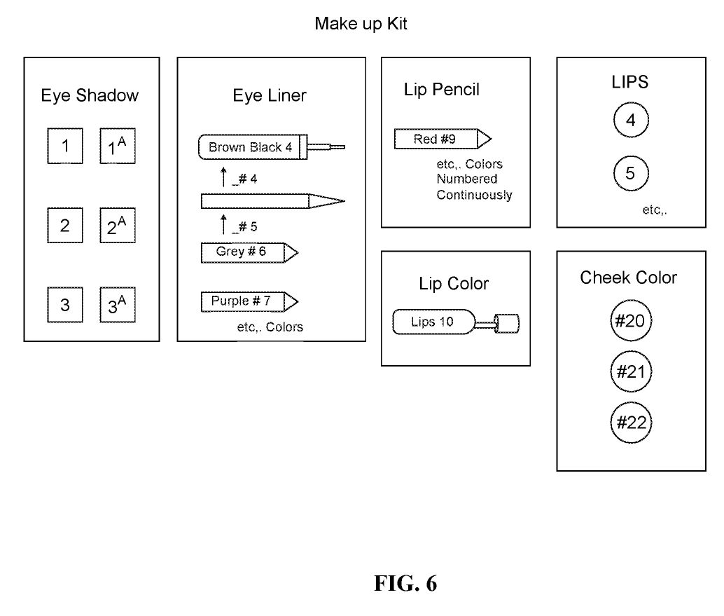

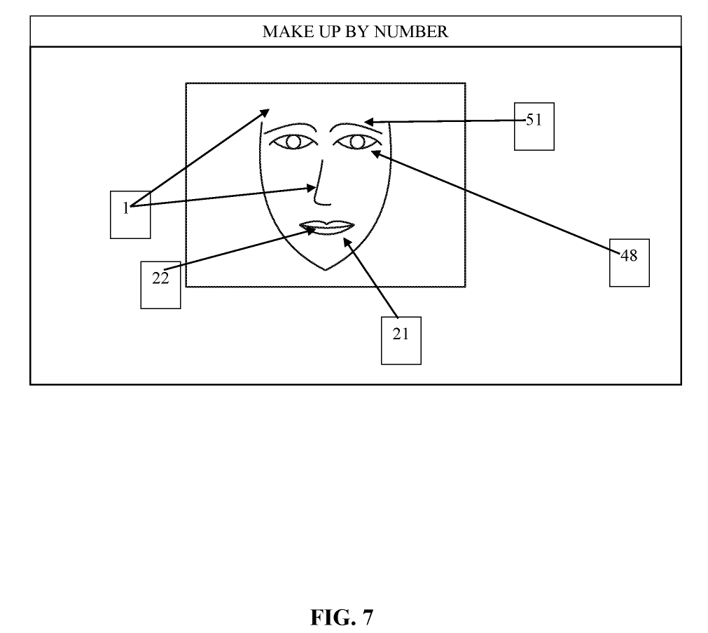

The make-up artist module 215 is configured to process the image. The make-up artist module 215 comprises an eye module 260 to generate eye contouring stencils models, a facial module 250 to generate facial contouring stencil models, a lip contouring module 245 to generate a lip stencil model, a cheek contouring module 255 to generate a cheek/blush stencil model, and an eyebrow module 240 to generate an eyebrow stencil module. In one example, the make-up artist module 215 uses at least one of image processing algorithms and facial recognition algorithms to determine a plurality of eyebrow metrics. The plurality of the eyebrow metrics are various metrics associated with the user's face. The plurality of eyebrow metrics comprises at least one of the length of eyebrows on the user's face, the bone structure of the user's face, the shape of the user's face, and the breadth of eyebrows on the user's face. In one example, the present invention enables the user to implement a paint by number based make-up system. FIG. 5 is an exemplary illustration of a screenshot of a paint by number based make-up system in accordance with one embodiment of the present invention. FIG. 6 is an exemplary illustration of a make-up kit used for a paint by number based make-up system in accordance with one embodiment of the present invention. FIG. 7 is an exemplary illustration of a screenshot of a paint by number based make-up system in accordance with one embodiment of the present invention.

Further, the make-up artist module 215 compares the plurality of eyebrow metrics with the plurality of eyebrow stencil metrics associated with each of the plurality of eyebrow stencil templates. Moreover, the make-up artist module 215 select at least one eyebrow stencil template from the plurality of eyebrow stencil templates based on the plurality of eyebrow metrics being identical to the plurality of eyebrow stencil metrics associated with the at least one eyebrow stencil template. Furthermore, the make-up artist module 215 transmits information regarding the at least one eyebrow stencil template to the make-up artist device 235. In one example, the make-up artist module 215 transmits the at least one eyebrow stencil template to an eyebrow stencil manufacturing factory via the network 230. The make-up artist device 235 receives information regarding the at least one eyebrow stencil template from the user device 240, and generates a custom eyebrow stencil based on the at least one eyebrow stencil template. The custom eyebrow stencil comprises a plastic fitting configured to fit between a nose bone of the user and an eye-socket of the user.

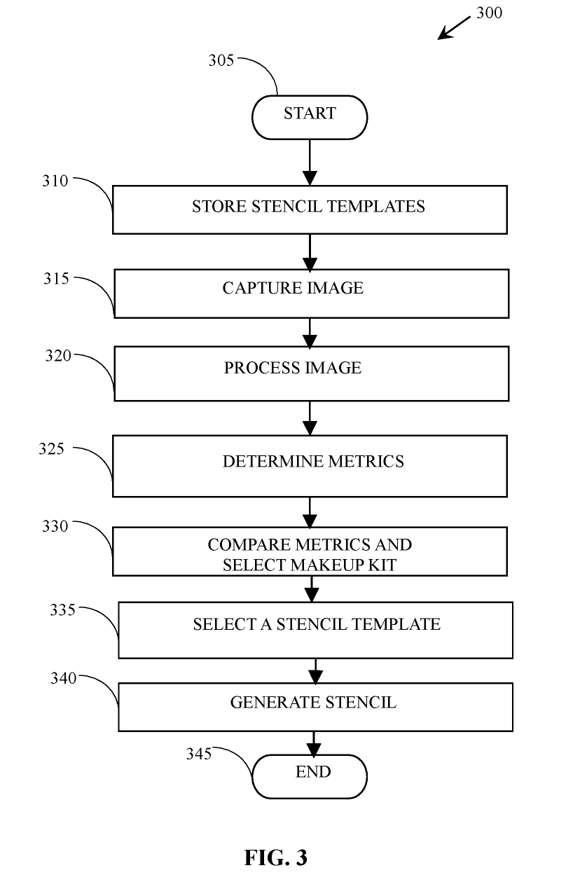

FIG. 3 is a flow chart illustrating a computer-implemented method 300 of generating a custom eyebrow stencil, according to yet another embodiment of the present invention. The method 300 is implemented in a user device. The user device is connected to a make-up artist device via a network. The network is at least one of a mobile network, a wide area network and a wireless radio network. The network enables communication between the make-up artist device and the user device. The user device comprises a processor, a memory unit, and a camera. The method 300 commences at step 305.

At step 310, the memory unit stores information regarding a plurality of eyebrow stencil templates. The information comprises a plurality of eyebrow stencil metrics associated with each of the plurality of the eyebrow stencil templates. The plurality of eyebrow stencil templates comprise wireframe 3d models of eyebrow stencils, surface 3d models of eyebrow stencils, and solid 3d models of eyebrow stencils. The plurality of the eyebrow stencil metrics comprises at least one of a length of eyebrows on a user's face, a bone structure of the user's face, a shape of the user's face, and breadth of the eyebrows. The memory unit further comprises a set of program modules. The set of program modules comprises an input module and a make-up artist module. The processor executes the set of program modules. The input module activates the camera.

At step 315, the input module captures an image of the user's face. The image is stored in the memory unit as at least one of a .bmp, .jpg, and .png file. Further, the input module transmits the image to the make-up artist module.

At step 320, the make-up artist module processes the image. The make-up artist module uses at least one of image processing algorithms and facial recognition algorithms to process the image.

At step 325 the make-up artist module determines a plurality of eyebrow metrics. The plurality of the eyebrow metrics are various metrics associated with the user's face. The plurality of eyebrow metrics comprises at least one of the length of eyebrows on the user's face, the bone structure of the user's face, the shape of the user's face, and the breadth of eyebrows on the user's face.

At step 330, the make-up artist module compares the plurality of eyebrow metrics with the plurality of eyebrow stencil metrics associated with each of the plurality of eyebrow stencil templates. Further, the make-up artist module receives from the user, a selection with regards to a make-up kit comprising stencils for face contouring, eyebrow shaping, eye contouring, and cheek contouring and blushing, and applying lipstick.

At step 335, the make-up artist module selects at least one eyebrow stencil template from the plurality of eyebrow stencil templates based on the plurality of eyebrow metrics being identical to the plurality of eyebrow stencil metrics associated with the at least one eyebrow stencil template. Furthermore, the make-up artist module transmits information regarding the at least one eyebrow stencil template to the make-up artist device. The make-up artist device receives information regarding the at least one eyebrow stencil template from the user device.

At step 340, the make-up artist device generates a custom eyebrow stencil based on the at least one eyebrow stencil template. The custom eyebrow stencil comprises a plastic fitting configured to fit between a nose bone of the user and an eye-socket of the user. In one example, generic eyebrow stencil fittings are also available.

The method 300 ends at step 345.

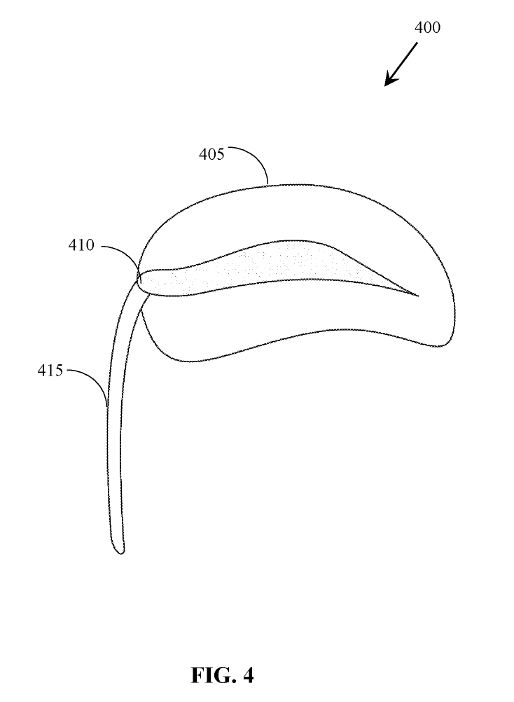

FIG. 4 is an exemplary illustration of an eyebrow stencil 400 according to yet another embodiment of the present invention. The eyebrow stencil 400 comprises a stencil layer 405, a stencil hole 410, and a plastic fitting 415. The plastic fitting 415 fits against a nose bone of a user and an eye socket of the user. Shape of the plastic fitting 415 results in placement of the eyebrow stencil 400 on a user's face to be exact every time. In one example, the plastic fitting 415 is made of vinyl. In another example, the user modifies shape on an eyebrow by placing the eyebrow stencil 400 on the user's face and rubbing on an eyebrow pigment. The eyebrow pigment is applied by rubbing on the eyebrow stencil with a rubbing stick.

Advantageously, custom eyebrow stencil form natural looking eyebrows. Further, the eyebrow stencil is convenient to use and saves time.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for generating an eyebrow stencil, the system comprising:
a user device comprising:
a camera;
a memory unit to store information about a plurality of eyebrow stencil templates, and a set of program modules,
wherein the information comprises a plurality of eyebrow stencil metrics associated with each of the plurality of the eyebrow stencil templates;
a processor to execute the set of program modules, wherein the set of program modules comprises:
an input module, executed by the processor, configured to activate the camera and capture an image of a user's face;
a make-up artist module, executed by the processor, configured to:
process the image to determine a plurality of eyebrow metrics,
compare the plurality of eyebrow metrics with the plurality of eyebrow stencil metrics associated with each of the plurality of eyebrow stencil templates, and
select at least one eyebrow stencil template from the plurality of eyebrow stencil templates based on the plurality of eyebrow metrics being identical to the plurality of eyebrow stencil metrics associated with the at least one eyebrow stencil template; and
a make-up artist device configured to:
receive information regarding the at least one eyebrow stencil template from the user device, and
generate an eyebrow stencil based on the at least one eyebrow stencil template.

2. The system of claim 1, wherein the make-up artist device is at least one of a stereolithographic 3d printer, Digital Light Processing (DLP) based 3d printer, Fused deposition modeling (FDM) based 3d printer, Selective Laser Sintering (SLS) based 3d printer, a Selective laser melting (SLM) 3d printer, Laminated Object Manufacturing (LOM) 3d printer.

3. The system of claim 1, wherein the user device is at least one of a laptop, a desktop computer, a mobile phone, and a personal digital assistant.

4. The system of claim 1, wherein the plurality of eyebrow stencil templates comprise at least one of wireframe 3d models of eyebrow stencils, surface 3d models of eyebrow stencils, and solid 3d models of eyebrow stencils.

5. The system of claim 1, wherein the plurality of the eyebrow stencil metrics and the plurality of eyebrow metrics comprises at least one of a length of eyebrows on the user's face, a bone structure of the user's face, a shape of the user's face, and breadth of the eyebrows.

6. The system of claim 1, wherein the eyebrow stencil comprises a plastic fitting configured to fit between a nose bone of the user and an eye-socket of the user.

7. A method of generating an eyebrow stencil, the method comprising:
storing in a memory unit, information about a plurality of eyebrow stencil templates, and a set of program modules, wherein the information comprises a plurality of eyebrow stencil metrics associated with each of the plurality of the eyebrow stencil templates;
activating a camera by a processor, via an input module;
capturing by the processor, via the input module, an image of a user's face;
processing, by the processor via an make-up artist module, the image to determine a plurality of eyebrow metrics;
comparing, by the processor via the make-up artist module, the plurality of eyebrow metrics with the plurality of eyebrow stencil metrics associated with each of the plurality of eyebrow stencil templates;
selecting, by the processor via the make-up artist module, at least one eyebrow stencil template from the plurality of eyebrow stencil templates based on the plurality of eyebrow metrics being identical to the plurality of eyebrow stencil metrics associated with the at least one eyebrow stencil template;
receiving at a make-up artist device, information regarding the at least one eyebrow stencil template from the user device; and
generating at the make-up artist device, an eyebrow stencil based on the at least one eyebrow stencil template.

8. The method of claim 7, wherein the make-up artist device is at least one of a stereolithographic 3d printer, Digital Light Processing (DLP) based 3d printer, Fused deposition modeling (FDM) based 3d printer, Selective Laser Sintering (SLS) based 3d printer, a Selective laser melting (SLM) 3d printer, Laminated Object Manufacturing (LOM) 3d printer.

9. The method of claim 7, wherein the user device is at least one of a laptop, a desktop computer, a mobile phone, and a personal digital assistant.

10. The method of claim 7, wherein the plurality of eyebrow stencil templates comprise at least one of wireframe 3d models of eyebrow stencils, surface 3d models of eyebrow stencils, and solid 3d models of eyebrow stencils.

11. The method of claim 7, wherein the plurality of the eyebrow stencil metrics and the plurality of eyebrow metrics comprises at least one of a length of eyebrows on the user's face, a bone structure of the user's face, a shape of the user's face, and breadth of the eyebrows.
